(19) United States
(12) Patent Application Publication
(10) Pub. No.: US 2007/0136763 A1
(43) Pub. Date: Jun. 14, 2007

(54) TNT data master & beyond or all digital studio hand or the ultimate duplication conversion or mobile intelligence or transformania PC (proper connectivity) or my mobilosophy or hand to handheld generation or mobile mogul or the all disposable PC or the conversion specialist or the all digital burn unit or mobile to mobiletainment or blend vision

(76) Inventors: La Tretha Ellonise Stroughter, Antioch, CA (US); Jerome William Smith, Oakland, CA (US)

Correspondence Address: LA TRETHA ELLONISE STROUGHTER, 2201 SYCAMORE DR., # 287, ANTIOCH, CA, 94509, US

(21) Appl. No.: 11/502,337

(22) Filed: Aug. 10, 2006

Related U.S. Application Data
(60) Provisional application No. 60/750,503, filed on Dec. 14, 2005.

(51) Int. Cl. H04N 7/20

(52) U.S. Cl. 725/63; 455/3.02; 386/46

(57) ABSTRACT

The TNT Datamaster and Beyond is a machine that incorporates all copying, duplication and transference recording conversion needs into one 60+″ or smaller unit. This product feature serves as a transaction computer, initial Internet base televisual blend classification to form a more enhanced digital transference device/personal recording studio. Using convenient performance/function keys, users can automatically copy their old music and videos onto unlimited hard drive space, CDs or DVDs. It also offers a turntable part to copy vinyl and computer connections for peripherals. It allows you to have your standard mixing CPU with CD-ROM-DVD ROM, Audiocassette, VCR, Turntable and 8-Track etc. You can transfer all data. Cassette Tapes easily break and you can lose songs that are hard to find that you may have had only on tape and this is good because cassette tapes are becoming obsolete.

### RELATED APPLICATIONS

The present application is a continuation-in-part application of U.S. provisional patent application Ser. No. 60/750,503, filed Dec. 14, 2005, for TNT DATA MASTER & BEYOND, by La Tretha E. Strougter, Jerome W. Smith, included by reference herein and for which benefit of the priority date is hereby claimed.

The present application is a continuation-in-part application of U.S. provisional patent application, Ser. No. US60/750,503, filed Dec. 14, 2005, for TNT DATA MASTER & BEYOND, by La Tretha E. Stroughter, Jerome W. Smith, included by reference herein and for which benefit of the priority date is hereby claimed.

This invention was created by La Tretha E. Stroughter and Jerome W. Smith in the years of Jan. 4, 1998 to 2003.

### FIELD OF THE INVENTION

The present invention relates to expert enhancements in duplication at warp speed through digital technology and more particularly to expose mainframe operations before and after specific duplications and activations are complete. This invention was created by La Tretha E. Stroughter and Jerome W. Smith in the years of Jan. 4, 1998 to 2003.

### BACKGROUND OF THE INVENTION

Ever since the beginning of music to media crossovers and duplications in studio style transformations, there has been multiple composed factors driven into a more modern digital logistics via enhanced integration, the solution and the need for more avenues, will sequined, maintain and keep key sources alive and for restoration remain always retrievable without a loss of studio media and duplications. This will no longer be a challenge.

Computer—D459,722 Garcia, Carlos, D456,400 Kim, Yong-Nam

Keyboard—3,932,866 Sasaki

Mouse—4,754,268 Mori

Remote Control, 3,940,701 Novitski

Cassette—D470,486 Cheung

CD-R medium Recording Method 6,363,040 Murata; Morihiro

System for managing Multimedia disks, tracks and files on a standalone computer 6,356,971 Katz, Norman P. et. al.

Television—Unknown, 8-Track—Unknown, Tower—Unknown, VCR—Unknown, CD Player—Unknown, DVD—Unknown

Some old rule of thumb and certain laws of gravitation at the time allowed cassettes, VHS, 8-Track Tapes and CD's/DVD's etc. to break, scratch, melt and static out way before its time and leaving a permanent scar on memories of old music media.

It is therefore an object of the invention to provide an automatic driver duplication in a massive copy conversion through all start ups of registries, maintain and processed like no other to record and manage in transit all of your past and present music to media archives.

It is another object of the invention to format an all disposable series intertwining with the TNT Data Master & Beyond, this includes operative mechanisms for major software deployment in music duplication once all transfers have occurred and completed, there is a 3 second self destruct interface mode that will occur for confidentiality, personal security all deriving around more personal systematic needs on the move.

It is another object of the invention to all together enhance and integrate vital based component organs and fine cell circuitry by taking this duplication enhancement full circle, creating a massive digitized impact on current and futuristic markets.

This system is designed to where there are multi-digital interfaces and mobile intertwining and intermingling with multiple ideas/concepts, applications and connections. For example: Duplication transistor connections which allows a versatile range in response and connectivity to super enhance this enriched performance level of Mobile Intelligence/Duplication This system includes a multi virus/Trojan free internal tool that enables system to self heal. This system is also designed with multiple internal duplication features.

It is another object of the invention to work along with other transference through televisual/audio devices and media hardware in desired areas without having to ever purchase extra duplication resonator connections, extra accessories or cables not unless user chooses to do so. Our main focus is to always focus on all Mobile Intelligence/Transference Conversions, whereas now a fiber optic server will be worn on a belt loop, through sensor concentrated, fine lines in circuitry for immediate response and spontaneous connectivity in hand to handheld generation devices, due to massive digital waves, probing monitors as well as frequency modulators and logistic receptors all evolving around the initial Internet base. This insinuates that not only our giant family systems will sore, but as well as our smaller on the move hand to handheld generation devices as well as Mobile Intelligence Devices for maximum mobilosophy such as, what you will see in our arraignment of cross transference mixed with several orchestrated methods of visual to audio duplications.

### SUMMARY OF THE INVENTION

In accordance with the present invention, there is provided The TNT Datamaster and Beyond et. al., this is a machine that incorporates all duplications for cross media and transference of solutions through duplications and cross conversion needs into one 60+″ or smaller unit. This product features a large monitor and serves as a multi duplication conversion computer that supports, copies and transfers all televisual, stereo, D.A.T. (Digital Audiotapes), which plays DVDs, CD's, VHS tapes, Audio Cassettes, Reel to Reel, and 8-Tracks. Through enhanced USB intelligence. This transference computer also supports all forms of movie Reel to Reel and playback resolutions by using convenient function keys, users can automatically copy their old media onto an unlimited hard drive, CDs or DVDs etc. It also offers a turntable part to copy vinyl and computer connections for peripherals. Like many devices, PDAs, Printers, Digital Cameras etc., the hard drive and RAM modifications are unlimited with multiple server capabilities and duplications. The system components are carefully packed into a device that substitutes for numerous separate equipment.

This system allows you to have your standard processor computer duplication conversion and an all digital burn unit with CD-ROM-DVD ROM, Audiocassette, VCR, Turntable, 8-Track. You can transfer all data from cassettes to CD ROM. Cassette Tapes easily break and you can lose songs that are hard to find that you may have had only on tape and this is good because cassette tapes are becoming obsolete.

The TNT Data Master & Beyond et. al gives you the all in one duplication/transference, instead of having to purchase a CD Burner to go with your digital audio component set. You can also copy your VCR tapes to DVD and be able to watch the DVD's on the TNT Data Master and Beyond Transvermation 1.5 Dimension Sun Screen Television Activity Monitor and the Swivel Stand. Through down time converting and pace circuitry integration, this system will support an all digital multi-tooth style cradled LESR (Local Enhanced Satellite Recording Hub) cable linked enhancement that will rendezvous digitally back and forth between silicon and magnetic strip coils for unlimited directional demolition style recordings and duplication/transfers. There may be separate small converter type systems that may imitate this machine but this is a machine that does not need an introduction, it accepts all modern day transfers, present, future and galactic responses like no other.

Along with the Regular PC Processor, adding the turntable, audiocassette, VCR, and the optional 8-Track, this all in one duplication/converter allows you to insert an audio cassette to play the tape and save each song either as a wave file or MP3 file etc. Adding the plug in digitally enhanced, USB style port formatting, that will allow you to play records (vinyl) and also have the option to plug in the turntable for multiple ? 0.1 in sound in usage of transferring old music onto the TNT Data Master and Beyond et. al. so you will never lose your favorite songs.

3 Second Self Destruct Interface Mode

Reverse digital drivers with high density interchange plus a unique first part, the TNT Data Master and Beyond et. al produces the 1st all disposable system and the 1st self destructible computer of the series. For example: You're in a rush to a very important meeting and you forgot your laptop by accident, you can run into any store and pick up a disposable/destructible TNT Data Master and Beyond so that you can receive your documents from the office via e-mail or online fax or etc. Once you've received what you need, you can push the self destruct mode, then you can throw it away and it will be destroyed and cannot be restored unless it's by a federal or government entity (optional).

Special Note: This invention was created by La Tretha E. Stroughter and Jerome W. Smith in the years of Jan. 4, 1998 to 2003.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an over all view of a tnt data master and beyond transvermation system;

FIG. 2 is a top view of a dynomouse;

FIG. 3 is a front view of an infrared remote;

FIG. 4 is a front view of a transvermation 1.5 dimension sun screen television activity monitor and the swivel stand;

FIG. 5 is a front view of a transvermation speakers;

FIG. 6 is a top view of a transvermation tnt keyboard/performance keys;

FIG. 7 is a front view of a transvermation tnt data master & beyond tower; and

FIG. 8 is a rear view of a transvermation digital portability unit.

For purposes of clarity and brevity, like elements and components will bear the same designations and numbering throughout the Figures.

### DESCRIPTION OF THE PREFERRED EMBODIMENT

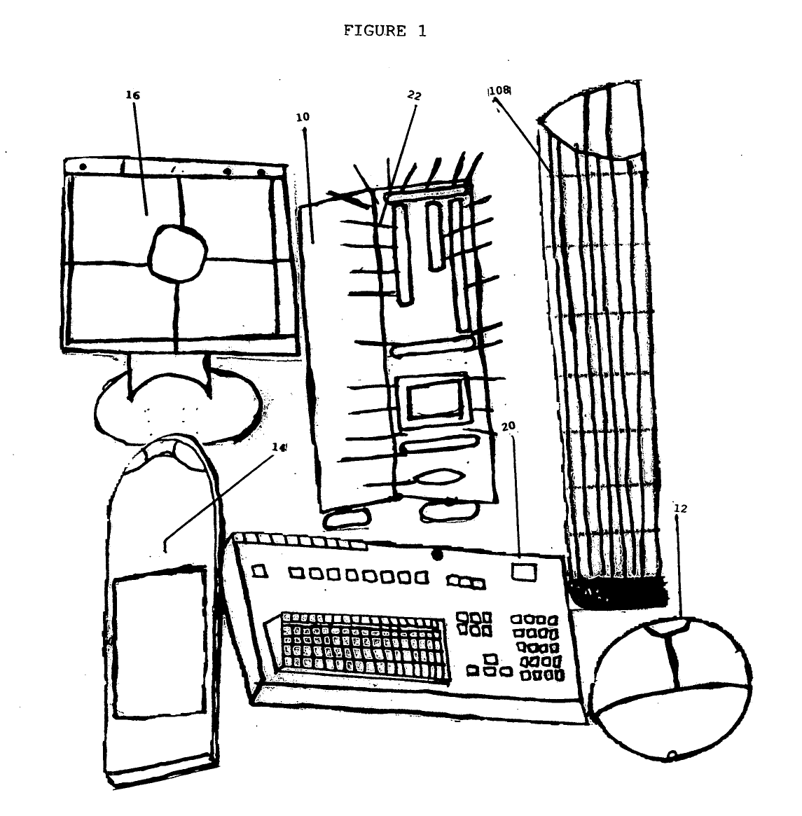

FIG. 1 is an over all view of a TNT Data Master and Beyond Transvermation System 10,

This system the TNT Data Master and Beyond Transvermation System 10 is designed as an all purpose digital duplication catalyst to where there are multi drones interfaced and mobile intertwining and intermingling with multiple conceptions/applications and connections such as special driver to driver recording and recognition, through highlighted graphics enabling user to watch every form of recording duplication and transfer on the Transvermation 1.5 Dimension Sun Screen Television Activity Monitor and the Swivel Stand 16 as well as assorted freeze applications, virtual pause, super motion enhancements and capabilities. All connections evolved around scroll networking allowing a versatile range of service effects in connections to super enhance this enriched performance level of Mobile Intelligence/Duplication with A-1 duplicating classifications. This system is designed with multiple internal features to work along with other televisions/audio and media hardware in desired areas without having to ever purchase extra duplication resonator connections, extra accessories or cables. Our main focus is to always focus on Mobile Intelligence/Duplication conversions, whereas now a server can be worn on a belt loop, sensor concentrated for immediate response and spontaneous connection with hand to handheld device, due to digital waves, probing monitors as well as frequency modulators and receptors all around the initial Internet base. This insinuates not only our giant family systems will sore, but as well as our smaller on the move hand to handheld generation devices for maximum mobilosophy such as, what you will see in our hand-to-handheld generation devices. Mini digital fiber optic resources such as disposable wireless components, will make up system hubs and housing departments as a whole. 3×3 mm receptors, ½ inch pin fiber modulators, ¼ inch adhesive band receptors for a distance in communication linkage and direct media response. ¼ inch adhesive stripping laced with fiber optic coil transmitters and receivers. 4 cm current receptors, ½ inch guided digital pin fiber translator circuits for constant back and forth relaying in operations. The weightless panels from side to side, front and back, are totally insulated with energy efficient cyber coolant insulation and coolant coil receptors, all ½ cm pores embedded inside system walls. Panels are made of fiber glass/duroplastic adhesive coatings, in all colors, shapes sizes or dimensions.

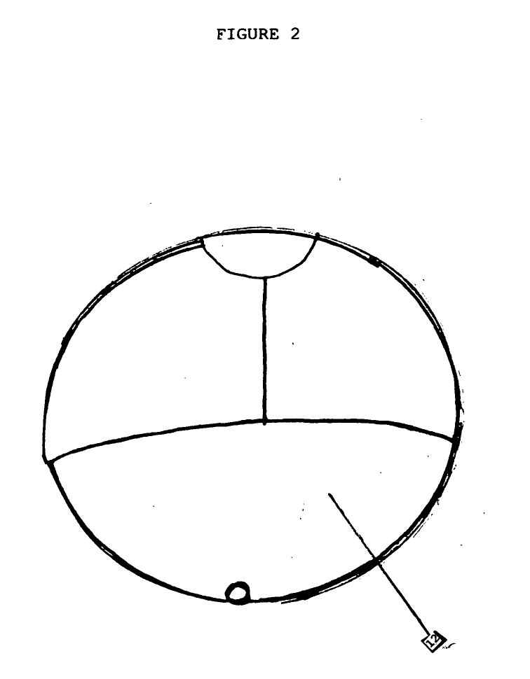

FIG. 2 is a top view of a Dynomouse 12. 5×5 inch circular disk top and bottom circular cone in shape. Multiple desired colors. Duroplastic coating/fiber glass coating firewall. Ergonomically correct/ambidextrous for posture. ½ inch resistor in board circuitry. (3) ½ inch remote sensor modules. Dual serial port connected. (2) ½ inch coils, transmitters for light signals. 10 pin inline package

Dynomouse 12 designed from hard duroplastic coating laser crafted, 220 mm to 300 mm gold tip wire converters and resonators laid out on flat/circular chip for a high volume of usage. The Dynomouse 12 is universal with high-density connectors, sensors, can be used to replace joystick, trackball, it's ideal for more mobilosophy control in futuristic systems.

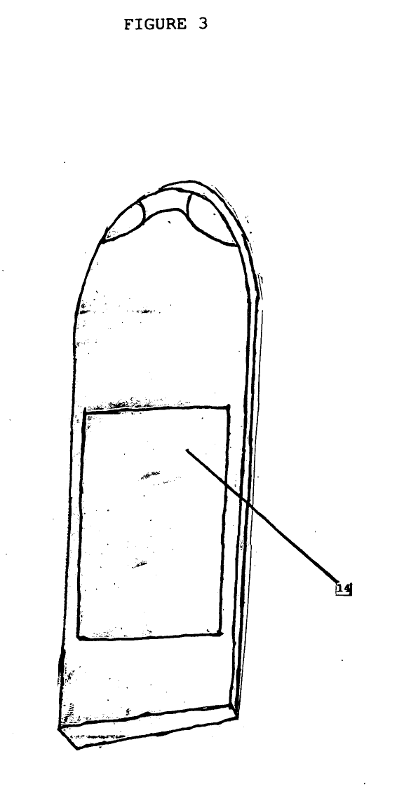

FIG. 3 is a front view of an Infrared Remote 14. ¼ inch in resistors or more/less in board circuitry. Remote sensor components/clear screen/touch screen, can be done in quarters or 3×3's in dimension or to desire, infrared modules, optic fiber size to millimeter size materials. Dual serial port connected. Infrared modulators and light beam signaling. 3½ inch to 5 inch in width. Multiple desired colors. Made out of duroplastic. Thumb and index grips.

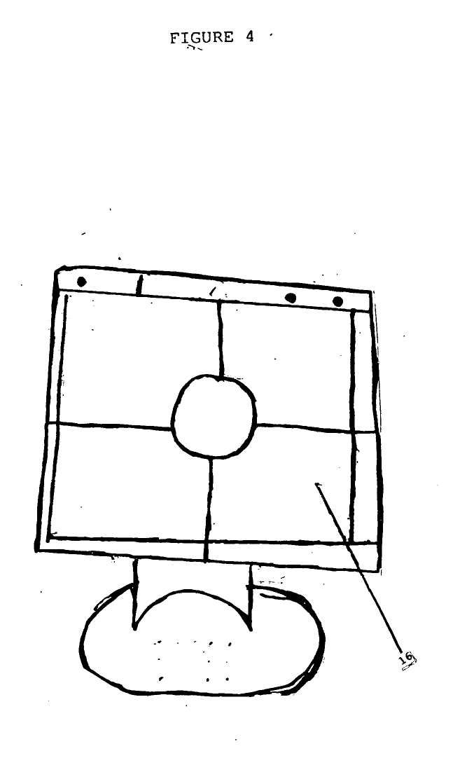

FIG. 4 is a front view of a Transvermation 1.5 Dimension Sun Screen Television Activity Monitor and the Swivel Stand 16. 1.5 Dimension Sun Screen will allow individuals to interact on 5 or more screens all at one time using quad supports of various circuitry interfaces, module devices, conductors and signal style receivers, ranging from 220 mm to ½ inch in size and dimension, depending on space capabilities. Monitor/Television: mini ½ inch, mini pixels for clarity and crossover contents along with many internal ¼ inch fiber style transmitters. Excellent rays for visioning and multiple ray transfer, along with multiple cable ready connections. Palm size 3½ inch to 60 inch screen. The Transvermation 1.5 Dimension Sun Screen Television Activity Monitor and the Swivel Stand 16 has a built in microphone and camera. The components consists of ¼ inch in circuit boards, infrared internal transmitters for 5-way focus viewing, for multiple screening for high density. Multi heat mechanisms for televisual use as well as computing and transference screen cams and microphone transmissions working overtime. High definition as well as digital interfacing is no problem using multiple receptors. ½ inch cube size transistors and reactors to handle the job. Internet based optimum TV and all cable duplication transference will be a plus on this system. The Swivel Stand is light weight made out of duroplastic, with light weight hard plastic coating, along with pivot wheel and two ply force brackets. The Swivel Stand is made up of duroplastic coils, motion brackets, and adjusters along with circular disk action. 1 inch in height to foot size, depending on desired height preference.

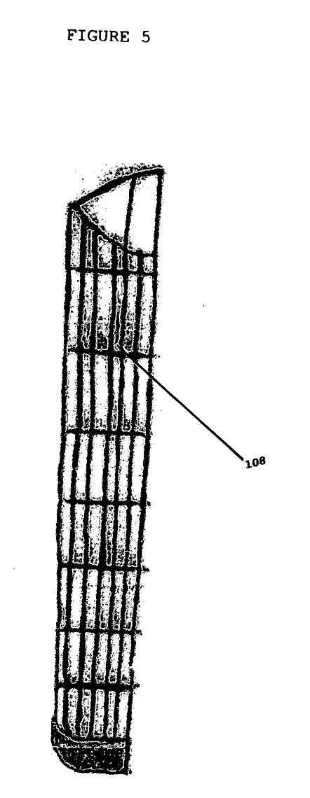

FIG. 5 is a front view of a Transvermation Speakers 108. The Transvermation Speakers 108 will range 3 to 24 inches in height, 3 to 5 inches in width, made out of duroplastic/fiber glass protection coating. Inside casing will be drivers/mid range cones; microbe style installation also coils approximately ½ inch in added coil rings. ½ inch modulators, cordless sensors with everything totally compact inside for space capacity also rhythm components. Inside panels also insulated with ¼ inch dual reactors and transmitters to control interference, improve clarity within channels, The Transvermation Speakers 108 will support wireless USB and built in wireless infrared sensor. Also equipped with cool zone antibodies in wireless wire-fications consisting of mini ½ cm of coolant conductor lines and coolant receptor hubs and ¼ inch coolant receptor module housing for immediate cold storage unit for personal choice.

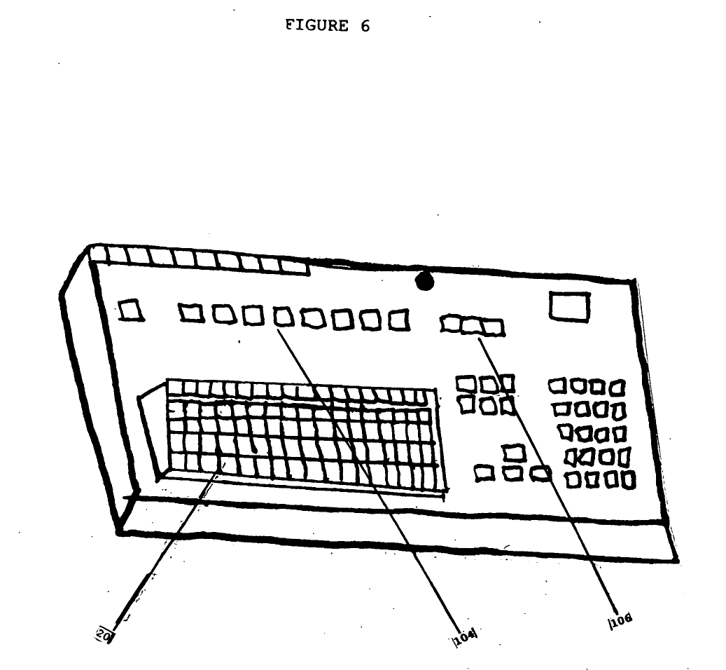

FIG. 6 is a front view of a Transvermation TNT Keyboard/Performance Keys 20, Virtual Conversion Quarters 104, Down and Dirty Digital Mind Renown 106 Transvermation TNT Keyboard/Performance Keys 20: 12 inches or more in fiber optic magnetic strip for internal use, many tiny molecules, crystals, high-density components for performance. The Keyboard is a standard keyboard size and width with 2 or more modern or customized keyboards for maximum capacity, remote censored, stringing back and forth through circuitry on motherboard. This keyboard has a special design made of duroplastic and adhesive coating and with multiple colors to choose from. The mute separation key consists of ¼ inch fiber optic coils, on time sensor, micro-circuitry. F1-F14 function keys consist of: According to sensor component style, 12 inch or more strip on keyboard function keys this will allow sensors to translate hand in hand with normal keys on motherboard of keypad, also ping ponging back and forth with terminal motherboard functions all by design, this will consist of many ½ inch molecule type crystal components that will bounce swiftly between other modules on keyboard for function key support.

Virtual Conversion Quarters 104: This special effects conversion will allow user, for example to take a picture that was 10 years ago and through virtual reality grids, you can do a complete portrait makeover from head to toe. Subtract or add hair, facial discrepancies, make up, pedicure, manicure, polishes you name it this application will make it happen by using the TNT Keyboard/Performance Keys and corresponding with tower and screen components which consists of micro millimeter silicon antibodies, mini micro mirror image transformers, illuminated coil ½ inch mm receptors and transistors, ½ inch hub and housing wireless units. All digital parental guidance.

Down and Dirty Digital Mind Renown 106: To virtually and digitally enhance old school fun on many different levels. For example: (Virtual realistic dominoes) This game is played virtually or online with as many partners imaginable, using all rules of dominoes and even being creative with new imaginary dominoes games. This game enables user to pick any settings such as night clubs, picnics, saloons, also many virtual identities and descriptions can be created for partners. (9 ball pool) This game enables user to contend on any level all over the world, virtually, using all billiard rules and even creating new games and techniques. (Ping Pong) This games uses all Ping Pong and Handball rules, virtually allowing user to create virtual partners. (Jacks) This game enables user to create virtually all forms and styles of game choices, creating virtual partners as well as online worldwide competitions. (Hop Scotch) This game enables user go back in time and virtually draw up many dimensions and strategies for this game on all levels, creating partners, Hop Scotch favorite songs and beats and many locations such as parks, school grounds or in front of the house. (Tether Ball, Kick Ball, Dodgeball, Strike Out and In verses the middle ball) Theses game enables user to play on all levels using virtual stability and digital aptitude and this game enables user to play online in competitions using virtual referees and also having fan base. (Quick Hand Slap, Coin Toss, Five Card Pick Up, 3 Card Molly, Pencil, Thumps, Marbles Extreme) These games enables users to virtually play on all levels of these creations, involving online competition, all ages of play with excellent digitized graphics. (Monkey Bar Climbing/Horizontal bar, Rock Fight, Hide and Seek, Freeze Tag, Jump Rope, High Jump Extreme, Red Light-Green Light. These games enables users to play on all extended levels virtually even in a matrix community all depending on creativity of the user. These games have tons of online competition and users can create virtual partners for one on one and brawl room style of play. The users of all of these games will be able to play on many enhanced levels of play such as beginner phase versions and in between versions to the extreme levels that involves sex and violence. (Virtual Bingo) this game that will be played for a fee of course 24 hours a day and available to play worldwide all languages possible etc. through digital minded schemes, The components consists of mini micro millimeter transistor tube bays. ½ mm transistors silicon mirror image sensors, mini cyber linked Teflon modulators, ½ micro millimeter hubs and housing gates, fully loaded with unrenowned bytes, all replaceable and removable for satellite and Internet enhancements.

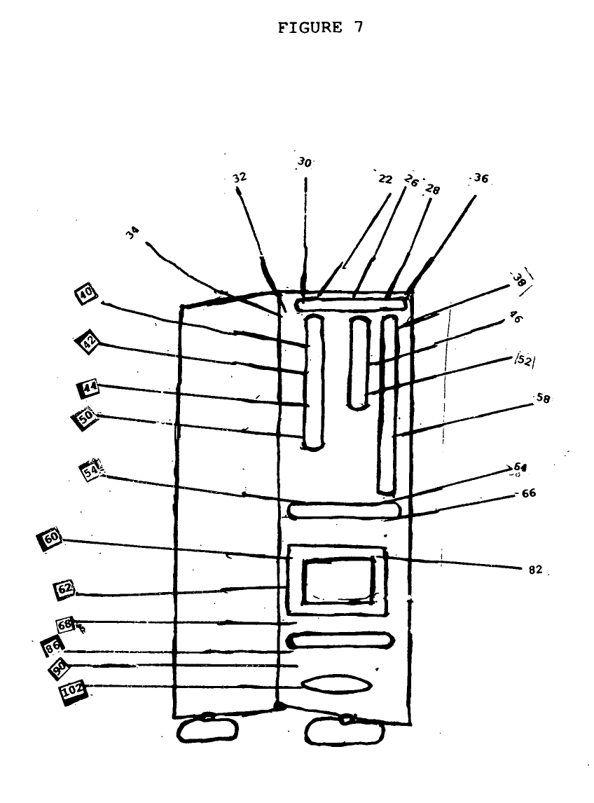

FIG. 7 is a front view of a Transvermation Tower 22. VCR Integration with Conversion style Multi Interface 26, D.A.T. Intelligence Style Interface Conversions (Digital Audio Tape) 28, Satellite All Digital, All Conversion Mixing, All Modern Day Digital Enhancements Conversions Through MP3 Slots Style Interface 32, Panoramic Integrations Via Virtual Conversions Through Digital Expansions 34, Multi Stack Conversion through Digital Processed Intelligence 36, Capacity Overload Conversions Start up System (Disk) 38, Blue Bay Remote Sensors 40, Extraordinary Conversion Ports such as Cellphone/Camera phone Ports 42, Modified Frequency Conversion 44, Terminal Conversion Receiver 46, Energy Efficient IAP Integration Protocol Conversions 50, Internal/External link Conversions 52, Sound/Tuner Cast Conversions 54, Necessity Conversions Such As Built In Snoozer Alarm 58, Built In Internal/External Microphone 60, Battery Back Up & Life Re-Storage Generator 62, Integration Through RAM Style Interface 64, Mini Cordless Sensor Signal Transmitters 66, Transvermation Zoom In Buttons 68, Quadra Zip Drive/Hard Drive Cross Interface 82, Multi-Wave Files/MPEG Style Formatting Transitions 86, Extensive Cable ready/Digital live Formatting 90, Conversion Pullout More Personal Expansions Such As CD Player 102,

Transvermation Tower 22 (Transformation and a massive converting process going hand in hand). Terminal can be standard in size or multi-dimensional to apprehend all bases or levels for usage in all colors, shapes and sizes, box will be insulated for all levels of operations. Tiny optic fibers along with several ½ inch digital coils and high level thin circuitry. Totally insulated with built in ½ inch air cooled modulators, insulated panels with duroplastic texture, many micro modules in CPU units, fiber tubing, ½ inch drivers, coils, receptors and Dolby style transmitters.

VCR Integration with Conversion style Multi Interface 26. This particular design can be done in the most experimental phase of the art or all standard with multi-interface production to accommodate desired times. Designed from digitized motherboard components, some old and some new, ½ inch modulators, 1 mm and above electronic crystals, receptors, ½ inch sensors, color-coded wiring and resonators. Reminder VCR playback and record functions will have a large enough drive in system to cross record and convert. This action has many DVR style functions, while watching favorite channels or duplicating, consulting and transacting transferences without any extra cable connectors or networking. These unique functions will allow the TNT Datamaster and Beyond and the consumer to be almost inseparable from their system, through these amazing 220 mm and above style molecules, mechanics and internal modulator components on motherboard.

D.A.T. Intelligence Style Interface Conversions (Digital Audio Tape) 28 to multiple cross convert any media mass production of any sort such as media, music, movies, digital crossover, and multi-Internet grazing during copy, duplication or transferring. The D.A.T. Intelligence Style Interface Conversions (Digital Audio Tape) 28 Slot is 3½ inches by 2 inches in dimension, using past and modern day components for motherboard and masterboard illustration with digital readings, digital transmission, digital response, and technician style sensor coding for precise and accurate clarity for massive studio converting, mastering, ping ponging tracks with no interference from signaling and multi mini components for balance and clarity. Blue Bay Digital and All Media Conversions: Cellphone/Camera Phone/MP3 Player Phone/Color TV Cable Ready PDA Handheld Computer Phone—Can be easily separated for on the move transport. Style modified interfacing (Modifications of application are inventors) Using multi or single circuitry, ½ mm stem or disk to install mini micro resonators and major miniature conductor units for astonishing results micro crossovers, transistors and transmitters now all can join in, in one small group for major results.

Initial Internet Base All Digital, All Conversion Mixing 30: Mixing can be multiple interfaced such as 3 or more sleek, mixing action and cross converting such as mixing play in reverse motion and massive speed for critical mixing. Using old school style DJ state of the art, mixing style mixing, 20 inches by 14 inches or more. Digital components for quick ping ponging or bouncing of transmitters for reference in sound. The Mixer ports Interface enables a professional level of disguising tracks, multiplying a single sound, reverse frequencies and signals, erase and multi-dub in and out subjects, media, movies, etc., you name it. The components consists of ½ inch to ¼ inch socket style port hole fully loaded with insulated wireless wiring, transmitters, infrared signaling to and from mini optic components. Instrument mixer ports consists of ½ inch to ¾ inch insulated pockets of digital wiring. Viewer Conversions such as Soft Touch/Tap Screen/Screen Savers by touch relying on split second reactors, signal response from motherboards, ½ inch components, micro-strips, mini sensors, for instant reaction between motherboards and wiring, point to touch signaling through screen system popups will go hand in hand with the TNT Data Master and Beyond Transvermation System 10, with split second advancements for wire to wireless recordable transfer communications for instant response, all in an insulated duct or optimum pocket.

All Modern Day Digital Enhancements Conversions Through MP3 Slots Style Interface 32: This particular interface will definitely change with the style and desired taste of individuals who collectively are adopted to spontaneous change and frequent experimental crossover, this will do it all. 7×2 in dimension using existing motherboard and disco style strobe lights insulation, ½ inch modulators, crystals, transmitters, digital sensors and multi-colored circuitry wiring and transistors. MP3 plug in ports consists of ½ inch and ¾ inch also 220 mm micro insulated, strenuous fiber optic ports, insulated for strenuous communicating, ping ponging between sensors and motherboard. Transvermation Conversion: consisting of many optic components for massive crossover media through Transvermation. Duroplastic casings, many component sleeves with air-cooled ducts for sensor revolution and code stringing.

Panoramic Integrations Via Virtual Conversions Through Digital Expansions 34: such as Cassette style Interfaces. This particular style of cassette enables you to play many particular style and size cassette cartridges, all in one based area, allowing music or media etc., to play alone without any buzz/fuzz or under any reverbal conditions for DJ Style spontaneous instrumental mixings creating a new style of television we call “Blend Vision”. Pace modules are 5×5 in dimension using digital interface technology, existing and futuristic motherboard layouts, multiple transmission channels for clear accurate production. Unlimited Card Interface Conversions: such as S Card/Video Card Interface: Enables individuals to share hours of long play through this style of editorial card modification, editing, mixing, and cross converting. 2½ inch by 1½ inch or larger style duroplastic outside coating, designed for magnetic re-writing, micro sensors, infrared and digital stringing of codes for accurate operation, coinciding with mass component streaming.

Multi Stack Conversion through Digital Processed Intelligence 36: Allowing a wide range of mass media chains such as CD/DVD extensive CD duplication/transference capabilities can be 7 to 10 tier CD Changer/Pull out for tag along purposes such as pull out from system to put into car, mounted in tower on orchestrated mini fiber wiring pins, also pin style modulators, digital interface, using CD/DVD conversions of existing motherboard gratifications, along with modern designs of circuitry, wiring, cells, components, along with clarity in sound combined with warp speed and recordable duplication. CD style pullouts will also contain gold fiber tips for connectors with motherboard reactors, transistor, and transmitter stripping, all about ¾ of an inch or so. Reverse, Quadra, re-writeable, extensions, reverse conversion action combined with old and new wireless units motherboard layouts for a space saver style motherboard, give or take a few dimensions in expansion capabilities for futuristic blueprints.

Capacity Overload Conversions Start up System (Disk) 38: Velocity-viscosity along with a massive conversion back and forth demonstration, synchronizing, digital motherboards, (2) combined micro-bit chips for accurate crossovers, channel manipulations, enabling system to bounce in and out of boundaries or limited areas through sensor components and resistors all at a touch of an on/off button or remote. This system is the ultimate duplication/transference, recording device that can constantly convert all music, studio material, massive television programming and extensive copying, all within a click of a button. All electronic executions from motherboard et. al. will house millimeter style housing hubs for liquid as well as cell formulated components, taking only a limited amount of space in area bays. Multi capable interludes allows users to probe system base through extensive mobile portability using disposable devices with critical key connections such as these devices and applications.

Blue Bay Remote Sensors 40: located ½ inch from bottom of all motherboard/masterboard devices for complete immediate response in all interference or electrical etc., conditions. Mini ½ inch transistors, resonators, signaling probes and infrared time sensors all combined in one, for accurate processing customized to fit desired function. This system enables users to constantly convert chambers of storage rooms of old filing material through a digital in/out transit conversion. Incredible scan recognition through infrared intelligent probes allows users to scan over several documents at a time as if you're in the grocery store, not only reads bar codes but it reads, writes, translates through a multiple smart conversion and recordable enhancements. The components include trillions of 12 way cube mirror shaped microns, probe settings, millimeter style silicon transistors, 3 and 4 way micro mirror elevation, image projectiles, all combined in one circuitry band or chip. This device will be connected or wireless for incredible right now or in the traffic of organizing.

Extraordinary Conversion Ports such as Cellphone/Camera phone Ports 42: Mounted precisely 2 inches between each end rear of tower, standard tower in height and width or customized for desired capacity in functions and adjustments. Dimensioning can be re-orchestrated through tower designs of digital sensors, ½ inch modulators, ¼ inch transistors, and fiber wiring on compact insulated motherboard. Multi-Mix Conversion Ports/Reel to Reel Commitments Digitally: Designed to actually handle maximum overload of many connections with premier support, supporting motherboard, all modulators, 1¾ modulators, ½ inch transistors and process unit, under quad conditions for speed our goal is always to convert with best quality clarity within circuitry and connection. 350 mm, ½ inch, ¼ inch in circular dimension style socket, fully loaded with miniature wiring bridges and gaps for transmitters and crossover, wiring sleeves for accurate signaling to bring Reel to Reel to a rebirth with clarity and sound. Mobility USB Ports Interface Conversion: There will be a variety of styles in this cross connection for digital as well as satellite future. ½ inch also ¾ inch fiber style wiring for excellent digital referencing, decoding, designed with insulation wall and fiber optic modules. Integrations Through 8 Track Interface Ports: Enables individuals to have sheer clear and crisp sounds through channels and frequencies, with this new style 8-Track evolution in port transmission and synchronizing of modified and digitally revised tracks. Transvermation Conversion consists of multi crossover media transitioning using many ¼ inch square or circular ports to occupy this unique style tower fully insulated with ½ inch and ¼ inch molecule type circuitry, with a digital capacity for maximum optic wiring. Printer Ports Interface Conversion: Through sensor script magnetization and demagnetization these ports can be utilized in a wide variety of major crossover mixing and synchronizing from port to port. ¼ inch square or circular insulated style port holes, loaded with digital sophistication in many ½ inch circuit board layouts along with insulated ducts, all coinciding with motherboard features in tower. Extensive Earphone Jacks-Port Interface: Insulated miniature ports built for wireless operations with combined component orchestrations from prior ports focusing on massive digital speed and signaling and miniature transmitters for accurate streaming. Mini ¼ inch, ½ inch, 1 mm cyber transistors for dial signaling, ear signaling, smooth volume and ear jack overload. Massive Cable Ready Server Port Interface: Enables multi-connections for multiple experiences through the Internet, satellite etc. ½ inch to ¼ inch circular or square ports for maximum digital reaction air-cooled with mini reactors and transmitters.

Modified Frequency Conversion 44: along with Digital camera/Camcorder/Cellphone/plug in port/3×5 high voltage insulated transmitter style wiring and core component layout responding with all wireless signals sensors and transmitters, plug in one or more at once. Through advanced deployment constant conversions and intelligence has arrived through an all digital matrix community, throughout system. This system will allow users to experience signal transfer through digital transformation all crafted into the circuitry, through sums of precision wireless effects, multiple gigabytes, terabytes in community enhanced integration. Through enhanced technology for demolition style recording, we have developed component implants, from circuitry wiring, wireless interludes, community formatting and the comprehensive state to assert more digital power in changeable pieces of a single circuitry grid through multiple and solar reprocessed tube modifications that includes unlimited battery life and on the move stabilization.

Terminal Conversion Receiver 46: Designed or made from up to date fire proof very cool fiber framing for all conditions of extensive operations. Features: built in spiral circuitry insulation, invisible multi-crystal gate along with dual fancy wireless wiring in house compartments are capable of interfacing with major incorporated bytes and all present and futuristic talks for system enhancement such as this one. Consists of insulated quarter panels, 250 mm or above circuitry wiring to enable absolute success in operation. Crystals/Gates are somewhat main attractions in tower because of speed and precision.

Energy Efficient IAP Integration Protocol Conversions 50: Consisting of 2 to 3 inches insulated pockets or maximum override capability to plug in for uploads/downloads, that's located either at rear or all sides of system. This also applies to the hand to handheld generation devices. Removable-Transport Microphone

Conversion: Also for constant on the move transport. Two reversible swirl insulated ½ mm modules inside with unbelievable full in house circuitry wiring, fiber transmitters, 1½×1½ inch all stored in miniature database storage drums. Internal/External Energy Probe Cam Conversions: For spontaneous photos, such as multi-dimensional slide extravaganzas as well as video production at all levels. 1×1 in circular dimension ½ inch deep fiber optic wiring and insulation, breathless feature, conductor units, as small as a pin head full of semi transistor/transmitter crossovers-All Infrared Integration Conversion: Through Universal Emergency Initial Internet Base Efficiency Radio Remote Control with one touch scanner and communicate internal/external action can be utilized and designed using ⅓ inch resonators, small conductors, fiber optic wiring, swirl insulated circuitry, all on miniature unified board layout.

Internal/External link Conversions 52: Mini built in modem to be able to differentiate frequencies and overload situations for constant ability to perform on the highest performance level And this may resort to a stand alone circuitry unit maybe minus, maybe plus in fiber optic resistors and transistor capabilities/Multiple digital features on compact motherboard, acquiring warp speed for processing, ¼ inch components, ¾ inch wire boxes, 1-inch sensors, dual circuitry for very high speed. Also for plush wiring techniques, in wireless agility modes. Enables users quicker record response time through music and fast media interactions, whether using pull out conversions or extensive mobility for travel. System conversion router is equipped with split second activations through digital monitoring, whether the integration is recording of media files or drivers. This particular enhancement is loaded with multiple base levels of detachable units, allowing users to always strengthen studio style elevation in integration.

Sound/Tuner Cast Conversions 54: This card will be available in all shapes, design patterns, sizes, with lightweight features. Even Cast Card prong to prong for plug in style cards. 3×5 inch slot very light in ounces, 1 mm to 5 inches in length, 1 mm to 3 inches in width, thermo insulated, insulated optic coils for sensitivity, also once in operation, great reliability in cycling throughout circuitry hubs coinciding with mini crystal gate avenues located throughout motherboard, ½ inch, ¾ inch, 350 mm or above transistors and resistors, magnetic coil strips for accurate digital response and split second readings in analysis, all coinciding with back and forth signaling for motherboard engines, recommending flexible definition pitch interface for an high aptitude communication base, expanding server file conversions rapidly by editing and diagnosing all system functions at a quick time pace.

Necessity Conversions Such As Built In Snoozer Alarm 58: Enables system to vocally wake you up, play any media or television shows images, vibrations or sounds to wake up person by timed settings, even sound tones or screen saver illuminations as well as little annoying sounds that you can't stand will prompt you to get up. The only way to append these sounds either will be manually, by voice as well as all system features such as Infrared Remote 14, mouse, keyboard, escape style keys etc. Mini ½ inch molecules, ½ inch transistors and reactors with quick digital LCD/LED style TelePrompTer readings, embedded in screen, 3×5 inches in dimension. Involving direct vivid image stabilization through system distributors and coil circuitry, producing all new and all digital optimum coding and decoding. Involving digital text formatting for a more simple process to process elevating with unlimited recordable conversions to the ninth power or better.

Built In Internal/External Microphone 60: (as in detachable or removable for massive surveillance in duplication and reproduction techniques). For constant on the move/motion, hidden microphone style body attachments for interview style communications etc., with the reliability of present and future miniature converters as well as digital crossover wire converters for systematic enhancement, routing and re-routing changes will be a breeze. 220 mm to 350 mm, circular disk with infrared sensors, transistors, many receptive devices for response, communication slips made out of optic wiring, coils and ½ inch modules.

Battery Back Up & Life Re-Storage Generator 62: Designed to withstand all conditions of operations and to stand with the machine for the life of the machine in times of power surges, electrical outages or very humid days, you never have to worry about losing any information while working through the generator or storage back up unit. The multi-power is yours. 5 inches in width or smaller, 2½ inches in length or longer, built in power generator, many ½ inch circuit boards, all internal wiring for split second response with motherboard connectors.

Integration Through RAM Style Interface 64: Ramification designed for all massive memory changes modifications or upgrades using two or more sequences in ramification if necessary and even in time will never lose a step. All expandable 920 mhz or higher depending on automatic ohms conductors for more stable life in system overload device and circuitry in multi digital connections.

Mini Cordless Sensor Signal Transmitters 66: (Wireless of course) Designed to enable individuals a guaranteed assurance of velocity and capability of outstanding electrical/digital synchronizations in the most proper forms for even more state of connection and simplicity. All expandable transmitters, ½ inch coils, sockets and fiber optic wireless provisions and optimum pockets of sheer digital reactors, transmission for warp speed response, through out system.

Transvermation Zoom In Buttons 68: The multiple state of multi-phase of transitioning through transmitters, optical, infrared, digital and many other major components from the global industry of high tech sensor operations in copying, duplicating and transference through Internet to Internet transfer using ½ inch focus magnets, (3) ½ inch glass viewers, infrared components along with ½ inch mini wiring.

Quadra Zip Drive/Hard Drive Cross Interface 82: Enables sky is the limit in this drive situation, semi-drivers, multi-drivers, or individual drivers working together, sent to work seconds apart or working alone in multi-dimensional conversion. 900 ghz in space, massive drivers (1-2) preferably miniature for space and additions. Warp speed information streaming through automation and digital components. ½ inch modules, thermo insulated wiring for digital sensor detection, split second timers, and high tech wiring for response corresponding with motherboard. Extensive A-Z Drivers: Designated Drive with synchronized action Multiple components for optic driver force, 5.0 or higher in megabytes for space. Mini small molecules with ½ inch digital devices, transmitters, miniature circuitry with two-inch condensers. Conversion Driver Expansions: Re-readable/Re-createable/Extended ROM Drivers-choice drivers, non-expendable ROM for extensive use in all avenues of multi-phase media duplication. ½ inch insulated drivers, replaceable, pull out style for higher interfacing with digital accuracy. All coinciding with motherboard, reactors, coil sleeves and transmitters.

Multi-Wave Files/MPEG Style Formatting Transitions 86: Formation, formatting, in multi-increments or large bytes depend on desire. With ½ inch connectors, transistors, many probes for communicating between different conversions of music, television and computing through a stream of coding and reactors for expert transmitting.

Extensive Cable ready/Digital live Formatting 90: wiring connections as well as old school wiring setups with top of the line technology style wiring, ½ inch component units, ½ inch ducts for media support, duplication networks always sharing with sensor system response.

Conversion Pullout More Personal Expansions Such As CD Player 102: For major on the move transport and easy handling, 4×1 and 4 inches deep featuring gold pin heads for connection to in house tower/server, for major transforming capabilities, 2½ inch slide tracks for smooth in and out motion of pullout, wireless fiber optic sensor for cordless headset or basic earplug with sensor transmitter (Inventor's Application)/CD/CD-R/CD-RW-

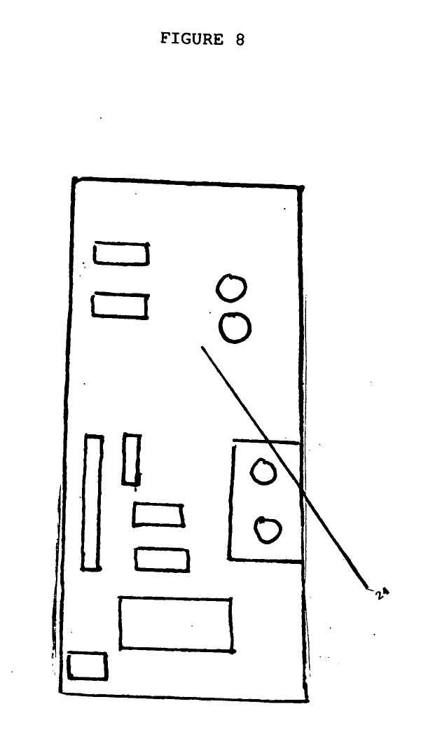

FIG. 8 is a rear view of a Transvermation Digital Portability Unit 24. The rear units of portability consists of all digital internal housings for separate conversion operations. All rear panels consists of either a plexiglass covering for any size or dimensions, nestled in compartment by portable plexiglass screws or fiberglass screws or duroplastics studs to hold panels in place with a snug fit. Mini ½ inch, ¼ inch, ¾ inch modulator departments, all wireless, with multiple glow or illuminations relay conductors. All applications and system operations complies with performance keys/function keys to conversion components base stations located in main conversion receiver or tower interface. There are many bays for conversion interfaces and integration, all coming from rear component and receivers, nestled in rear panels of the TNT Data Master and Beyond et. al. Multi back up transmissions consists of mini ½ cm circuitry organs that makes up a full bandlength, a full bandwidth possessing a massive impact in all internal ¼ inch fixed, pushed style components. The TNT Data Master and Beyond Transvermation System 10 is something we would like to relate to it as the conversion specialist, that's very aggressive and has massive intelligence, well rounded and most effective. Integration through Scan Portability: Enables individuals to cross scan while regular/multi-scan process is in process with separate memory gauges for critical scan preference. All ½ inch or ¼ inch optic mechanisms, generated through sensors, stringing infrared signals all on one chip attached to motherboard.

Special Note: Integrated software will be designed by expert researchers and/or scientific studies of the art of converting, digital, synchronizing, coding and formatting by high tech analyst that create new languages to ensure that all hardware ran by the TNT Data Master and Beyond Transvermation System 10 will run correctly, also simultaneously along with existing product lines, also a combination of technological fields, from today's layouts of circuitry and wiring along with futuristic assembly lines. Our theory is to have spontaneous response time, between hardware/software for advanced digital intertwining. Timing has always been our major focus, so in theory, minor delays, plus micro-second activation will now equal a combustion of digital coding, streamline of infrared and sensor signaling that will express a multi wave of new styles of number synchronizing through future operations for decades to come. TNT (Dynamite) Exploding Screen Saver: integrated results of digital aptitude in crafts and analogies creating such ray interludes and many common ½ inch transistors, resonators, that can only be done through digital scientific research. This invention was created by La Tretha E. Stroughter and Jerome W. Smith in the years of Jan. 4, 1998 to 2003.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision for through all mobile conversion enhancements and through omni/g-force circuitry integration users are enabled to convert all mass media conversion utility along with mainframe communication via broad/wireless communication such as 78, 45's 33's, cd's, dvd's, cassettes, 8-tracks, vhs, etc. into system or on standard up to date media utility through informant transformation integration, comprising:
means for the tnt data master & beyond to incorporate all entertainment metamorphosis and transfer needs through major streamline thoroughways and frequency modulating into one 62 inch transvermation 1.5 dimension sun screen television activity monitor through coversion magic, higher or lower in inches depending on preferences;
means for the dynomouse to correspond with system through mouse control;
means for the infrared remote to remotely control the system;
means for the 1.5 dimension sunscreen television activity monitor and the swivel stand to be able to convert multi cable and satellite and perform a mirage of computerized activities at the same time and the swivel stand to be able to move in multiple directions on catalyst or manually;
means for the transvermation speakers to digitally incorporate massive sound and ventilation controls as well as special effect lighting all digital through test tube lighting;
means for the transvermation tnt keyboard/performance keys to perform major multi task through wireless simulation automation conversions;
means for virtual conversion quarters to convert and re-convert old commodities to suitable taste, securely connected to said means for the transvermation tnt keyboard/performance keys to perform major multi task through wireless simulation automation conversions;
means for the down and dirty digital mind renown to virtually and digitally enhance old school fun on many different levels for example virtual realistic dominoes, securely connected to said means for the transvermation tnt keyboard/performance keys to perform major multi task through wireless simulation automation conversions;
means for the transvermation tower to generate quadra transfers and conversions through air bellow transitions to perform many types of media conversions, wireless connected to said means for the down and dirty digital mind renown to virtually and digitally enhance old school fun on many different levels for example virtual realistic dominoes, wireless connected to said means for virtual conversion quarters to convert and re-convert old commodities to suitable taste, wireless connected to said means for the transvermation tnt keyboard/performance keys to perform major multi task through wireless simulation automation conversions, wireless connected to said means for the transvermation speakers to digitally incorporate massive sound and ventilation controls as well as special effect lighting all digital through test tube lighting, wireless connected to said means for the 1.5 dimension sunscreen television activity monitor and the swivel stand to be able to convert multi cable and satellite and perform a mirage of computerized activities at the same time and the swivel stand to be able to move in multiple directions on catalyst or manually, wireless connected to said means for the infrared remote to remotely control the system, wireless connected to said means for the dynomouse to correspond with system through mouse control, and wireless connected to said means for the tnt data master & beyond to incorporate all entertainment metamorphosis and transfer needs through major streamline thoroughways and frequency modulating into one 62 inch transvermation 1.5 dimension sun screen television activity monitor through coversion magic, higher or lower in inches depending on preferences;
means for the vcr integration with conversion style multi interface to digitally convert mass quantities of media activities, combined with unorchestrated volumes of communication enhancements, securely connected to said means for the transvermation tower to generate quadra transfers and conversions through air bellow transitions to perform many types of media conversions;
means for the d.a.t. intelligence style interface conversions (digital audio tape) to selectively engage in digital special effects in studio interface to integration connectivity operations, securely connected to said means for the transvermation tower to generate quadra transfers and conversions through air bellow transitions to perform many types of media conversions;
means for the initial internet base all digital, all conversion mixing to cross convert multi mix style integrations from audio to visual to communication as well as ada specifications and all forms of translations mix factors, securely connected to said means for the transvermation tower to generate quadra transfers and conversions through air bellow transitions to perform many types of media conversions;
means for the all modern day digital enhancements conversions through mp3 slots style interface to enhance conversion navigation, explicitly rotating all levels of any serious varieties of mobile massive cargo, securely connected to said means for the transvermation tower to generate quadra transfers and conversions through air bellow transitions to perform many types of media conversions;
means for the panoramic integrations via virtual conversions through digital expansions to express the most vivid archives of multiple versatile tooth ray cross integration possible, securely connected to said means for the transvermation tower to generate quadra transfers and conversions through air bellow transitions to perform many types of media conversions;
means for the multi stack conversion through digital processed intelligence to aggressively save and combine massive libraries of conversion processing, extensively through integration housing bays embedded within multiple units of driver laboratories, securely connected to said means for the transvermation tower to generate quadra transfers and conversions through air bellow transitions to perform many types of media conversions;
means for the capacity overload conversions start up system (disk) to systematically compose all integration illustrations into one gate for a rapid start up surge, securely connected to said means for the transvermation tower to generate quadra transfers and conversions through air bellow transitions to perform many types of media conversions;
means for the blue bay remote sensors to orchestrate massive cross signaling throughout system for repeatedly rapid response for rapid operations, securely connected to said means for the transvermation tower to generate quadra transfers and conversions through air bellow transitions to perform many types of media conversions;
means for the extraordinary conversion ports such as cellphone/camera phone ports to digitally incorporate all signal/sensor portability within milliseconds in relationship, securely connected to said means for the transvermation tower to generate quadra transfers and conversions through air bellow transitions to perform many types of media conversions;
means for the modified frequency conversion to channel up, cross spit fire conversions through digital wave sequence and digital integration circumference with maximum standards in readiness, securely connected to said means for the transvermation tower to generate quadra transfers and conversions through air bellow transitions to perform many types of media conversions;
means for the terminal conversion receiver to ultimately force digital streamlines of satellite bandwidth to form an extra strike impact in wave ratio and system production, securely connected to said means for the transvermation tower to generate quadra transfers and conversions through air bellow transitions to perform many types of media conversions;
means for the energy efficient iap integration protocol conversions to convert hand in hand with all media communications and probe satellite orchestrations as well as basic one on one cable enhancements digitally, securely connected to said means for the transvermation tower to generate quadra transfers and conversions through air bellow transitions to perform many types of media conversions;
means for the internal/external link conversions to form a massive media to communication community all within a fiber optic streamline of synchronized reproduction modules, securely connected to said means for the transvermation tower to generate quadra transfers and conversions through air bellow transitions to perform many types of media conversions;
means for the sound/tuner cast conversions to convert massive swing operations through massive byte size circuitry pins all embedded on board or mm size fiber grid, securely connected to said means for the transvermation tower to generate quadra transfers and conversions through air bellow transitions to perform many types of media conversions;
means for the necessity conversions such as built in snoozer alarm to enhance a multiple new classification in wireless sensor configurations through advance analog and excessive exceleration for more on time connections, securely connected to said means for the transvermation tower to generate quadra transfers and conversions through air bellow transitions to perform many types of media conversions;
means for the built in internal/external microphone to involve multiple digital effects in a wireless spectrum of surround pan scanning and synchronized composed sequences, securely connected to said means for the transvermation tower to generate quadra transfers and conversions through air bellow transitions to perform many types of media conversions;
means for the battery back up & life re-storage generator to generate trillions of life cells within titanium style housing hub to form life even after the machine, securely connected to said means for the transvermation tower to generate quadra transfers and conversions through air bellow transitions to perform many types of media conversions;
means for the integration through ram style interface to selectively produce unrenowned combinations of memory access by multiple compartments of universal wireless intelligence working overtime, securely connected to said means for the transvermation tower to generate quadra transfers and conversions through air bellow transitions to perform many types of media conversions;
means for the mini cordless sensor signal transmitters to mingle and intertwine in many specific areas at one time to form an alliance of response cells through all digital transmissions, securely connected to said means for the transvermation tower to generate quadra transfers and conversions through air bellow transitions to perform many types of media conversions;
means for the transvermation zoom in buttons to cross interface and override all forms of close encounter zoom and wide range entities to form a more aggressive and prompt ally through spit fire zoom intelligence, securely connected to said means for the transvermation tower to generate quadra transfers and conversions through air bellow transitions to perform many types of media conversions;
means for the quadra zip drive/hard drive cross interface to multi focus from a wide variety of ranges within circumference of a net base, enhanced cable ready colony for maximum handling and a more personal systematic relationship in a futuristic digital universe, securely connected to said means for the transvermation tower to generate quadra transfers and conversions through air bellow transitions to perform many types of media conversions;
means for the multi-wave files/mpeg style formatting transitions to informatively reproduce potential memory identifiers through energy absorbing emissions, securely connected to said means for the transvermation tower to generate quadra transfers and conversions through air bellow transitions to perform many types of media conversions;
means for the extensive cable ready/digital live formatting to consecutively recruit massive forms of stream cells through digital converting of media/communications and all new styles of mobile life abroad, securely connected to said means for the transvermation tower to generate quadra transfers and conversions through air bellow transitions to perform many types of media conversions;
means for the conversion pullout more personal expansions such as cd player to allow mobilosophy in the life in which we live, allowing individuals to manifest any conversion possible being able to customize constantly while they're doing it moving, securely connected to said means for the transvermation tower to generate quadra transfers and conversions through air bellow transitions to perform many types of media conversions; and
means for the transvermation digital portability unit to enable user to structure portability manually through remote systems and to translate circuit to circuit transactions with kamikaze infrastructure, securely connected to said means for the transvermation tower to generate quadra transfers and conversions through air bellow transitions to perform many types of media conversions.

2. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the tnt data master & beyond to incorporate all entertainment metamorphosis and transfer needs through major streamline thoroughways and frequency modulating into one 62 inch transvermation 1.5 dimension sun screen television activity monitor through coversion magic, higher or lower in inches depending on preferences comprises a circular/square/rectangular, illuminates, duroplastic/plexiglass, zero ounces in weight tnt data master and beyond transvermation system.

3. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the dynomouse to correspond with system through mouse control comprises a round, zero ounces in weight, multi colors, duroplastic coating, illuminates dynomouse.

4. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the infrared remote to remotely control the system comprises a square/oval, illuminates, zero ounces in weight, multi colors, duroplastic coating infrared remote.

5. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the 1.5 dimension sunscreen television activity monitor and the swivel stand to be able to convert multi cable and satellite and perform a mirage of computerized activities at the same time and the swivel stand to be able to move in multiple directions on catalyst or manually comprises a square, illuminates, zero ounces in weight, 3 buttons on top layer of frame, multi colors transvermation 1.5 dimension sun screen television activity monitor and the swivel stand.

6. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the transvermation speakers to digitally incorporate massive sound and ventilation controls as well as special effect lighting all digital through test tube lighting comprises a round, special effect lighting, digital, climate control, zero ounces in weight, multi colors, duroplastic and fiber glass coating transvermation speakers.

7. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the transvermation tnt keyboard/performance keys to perform major multi task through wireless simulation automation conversions comprises a square, illuminates, multi colors, zero ounces in weight, flat transvermation tnt keyboard/performance keys.

8. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for virtual conversion quarters to convert and re-convert old commodities to suitable taste comprises a square, illuminates, multi colored, glow key enhancements, duroplastic key moldings virtual conversion quarters.

9. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the down and dirty digital mind renown to virtually and digitally enhance old school fun on many different levels for example virtual realistic dominoes comprises a square illuminated keys, multi colored, zero ounces in weight, duroplastic base, glow key surface down and dirty digital mind renown.

10. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the transvermation tower to generate quadra transfers and conversions through air bellow transitions to perform many types of media conversions comprises a square or flat, zero ounces in weight, multi colors, duroplastic coating, illuminates transvermation tower.

11. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the vcr integration with conversion style multi interface to digitally convert mass quantities of media activities, combined with unorchestrated volumes of communication enhancements comprises an oblong oval shaped, multi-colored, illuminated/glo beams, soft cohesive plastic, miniature bit probes vcr integration with conversion style multi interface.

12. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the d.a.t. intelligence style interface conversions (digital audio tape) to selectively engage in digital special effects in studio interface to integration connectivity operations comprises a squared, multi colored, light enhanced, metal inserts, soft duro plastic molding, graphite edges d.a.t. intelligence style interface conversions (digital audio tape).

13. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the initial internet base all digital, all conversion mixing to cross convert multi mix style integrations from audio to visual to communication as well as ada specifications and all forms of translations mix factors comprises a circular, illuminated, plexi plastic base, multi colored, glo beam circuitry initial internet base all digital, all conversion mixing.

14. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the all modern day digital enhancements conversions through mp3 slots style interface to enhance conversion navigation, explicitly rotating all levels of any serious varieties of mobile massive cargo comprises a square, illuminates, duroplastic, graphite inserts, glo coils inserts all modern day digital enhancements conversions through mp3 slots style interface.

15. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the panoramic integrations via virtual conversions through digital expansions to express the most vivid archives of multiple versatile tooth ray cross integration possible comprises a square, illuminates, multi tooth ray enhancements, duroplastic surface, graphite moldings panoramic integrations via virtual conversions through digital expansions.

16. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the multi stack conversion through digital processed intelligence to aggressively save and combine massive libraries of conversion processing, extensively through integration housing bays embedded within multiple units of driver laboratories comprises a square, illuminates, glo circuitry, graphite molding, plexiglass inserts, energy efficient tubing multi stack conversion through digital processed intelligence.

17. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the capacity overload conversions start up system (disk) to systematically compose all integration illustrations into one gate for a rapid start up surge comprises a square, graphite molding, illuminates, zero ounces in weight, duroplastic coating capacity overload conversions start up system (disk).

18. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the blue bay remote sensors to orchestrate massive cross signaling throughout system for repeatedly rapid response for rapid operations comprises a round, graphite surface, plexiglass moldings, illuminates, zero ounces in weight blue bay remote sensors.

19. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the extraordinary conversion ports such as cellphone/camera phone ports to digitally incorporate all signal/sensor portability within milliseconds in relationship comprises a round, illuminates, zero ounces in weight, graphite molding, duroplastic coating extraordinary conversion ports such as cellphone/camera phone ports.

20. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the modified frequency conversion to channel up, cross spit fire conversions through digital wave sequence and digital integration circumference with maximum standards in readiness comprises a round, graphite surface, duroplastic molding, zero ounces in weight, illuminates, multiple glo circuitry modified frequency conversion.

21. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the terminal conversion receiver to ultimately force digital streamlines of satellite bandwidth to form an extra strike impact in wave ratio and system production comprises a round module, graphite surface, plexiglass moldings, duroplastic sidings, zero ounces in weight, illuminates, glo circuitry terminal conversion receiver.

22. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the energy efficient iap integration protocol conversions to convert hand in hand with all media communications and probe satellite orchestrations as well as basic one on one cable enhancements digitally comprises a round, illuminates, graphite base, integrated duroplastic molding, zero ounces in weight, glo circuitry energy efficient iap integration protocol conversions.

23. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the internal/external link conversions to form a massive media to communication community all within a fiber optic streamline of synchronized reproduction modules comprises a round, illuminated circuitry, zero ounces in weight, graphite coils, duroplastic molding, plexi adhesive siding internal/external link conversions.

24. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the sound/tuner cast conversions to convert massive swing operations through massive byte size circuitry pins all embedded on board or mm size fiber grid comprises an oval, graphite base, zero ounces in weight, illuminated circuitry, pin fiber optic wiring, duroplastic base sound/tuner cast conversions.

25. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the necessity conversions such as built in snoozer alarm to enhance a multiple new classification in wireless sensor configurations through advance analog and excessive exceleration for more on time connections comprises a round, graphite base, zero ounces in weight, illuminated circuitry, duroplastic molding necessity conversions such as built in snoozer alarm.

26. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the built in internal/external microphone to involve multiple digital effects in a wireless spectrum of surround pan scanning and synchronized composed sequences comprises a round, zero ounces in weight, illuminated circuitry, graphite base built in internal/external microphone.

27. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the battery back up & life re-storage generator to generate trillions of life cells within titanium style housing hub to form life even after the machine comprises a square, zero ounces in weight, titanium base, illuminated circuitry, graphite moldings, duroplastic edges battery back up & life re-storage generator.

28. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the integration through ram style interface to selectively produce unrenowned combinations of memory access by multiple compartments of universal wireless intelligence working overtime comprises a round, graphite base, illuminated circuitry, zero ounces in weight, duroplastic coating, plexiglass inserts integration through ram style interface.

29. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the mini cordless sensor signal transmitters to mingle and intertwine in many specific areas at one time to form an alliance of response cells through all digital transmissions comprises a round, graphite base, illumination circuitry, zero ounces in weight, multiple colors, duroplastic coating mini cordless sensor signal transmitters.

30. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the transvermation zoom in buttons to cross interface and override all forms of close encounter zoom and wide range entities to form a more aggressive and prompt ally through spit fire zoom intelligence comprises a round, graphite base, illuminate circuitry, duroplastic base, zero ounces in weight, multiple colors transvermation zoom in buttons.

31. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the quadra zip drive/hard drive cross interface to multi focus from a wide variety of ranges within circumference of a net base, enhanced cable ready colony for maximum handling and a more personal systematic relationship in a futuristic digital universe comprises a round, zero ounces in weight, graphite base, illuminated circuitry, glo sensors, multiple colors, duroplastic moldings quadra zip drive/hard drive cross interface.

32. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the multi-wave files/mpeg style formatting transitions to informatively reproduce potential memory identifiers through energy absorbing emissions comprises a round, zero ounces in weight, illuminated circuitry, graphite base, duroplastic molding multi-wave files/mpeg style formatting transitions.

33. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the extensive cable ready/digital live formatting to consecutively recruit massive forms of stream cells through digital converting of media/communications and all new styles of mobile life abroad comprises a round, graphite base, illuminated circuitry, glo wiring, zero ounces in weight extensive cable ready/digital live formatting.

34. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the conversion pullout more personal expansions such as cd player to allow mobilosophy in the life in which we live, allowing individuals to manifest any conversion possible being able to customize constantly while they're doing it moving comprises a multi shaped, zero ounces in weight, multiple colors, graphite base, duroplastic coating, glow circuitry, illuminated wiring conversion pullout more personal expansions such as cd player.

35. The tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision in accordance with claim 1, wherein said means for the transvermation digital portability unit to enable user to structure portability manually through remote systems and to translate circuit to circuit transactions with kamikaze infrastructure comprises a square, mini grooves, mini notches, zero ounces in weight, illuminates, multi colors, duroplastic/rubber transvermation digital portability unit.

36. A tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision for through all mobile conversion enhancements and through omni/g-force circuitry integration users are enabled to convert all mass media conversion utility along with mainframe communication via broad/wireless communication such as 78, 45's 33's, cd's, dvd's, cassettes, 8-tracks, vhs, etc. into system or on standard up to date media utility through informant transformation integration, comprising:
a circular/square/rectangular, illuminates, duroplastic/plexiglass, zero ounces in weight tnt data master and beyond transvermation system, for the tnt data master & beyond to incorporate all entertainment metamorphosis and transfer needs through major streamline thoroughways and frequency modulating into one 62 inch transvermation 1.5 dimension sun screen television activity monitor through coversion magic, higher or lower in inches depending on preferences;
a round, zero ounces in weight, multi colors, duroplastic coating, illuminates dynomouse, for the dynomouse to correspond with system through mouse control;
a square/oval, illuminates, zero ounces in weight, multi colors, duroplastic coating infrared remote, for the infrared remote to remotely control the system;
a square, illuminates, zero ounces in weight, 3 buttons on top layer of frame, multi colors transvermation 1.5 dimension sun screen television activity monitor and the swivel stand, for the 1.5 dimension sunscreen television activity monitor and the swivel stand to be able to convert multi cable and satellite and perform a mirage of computerized activities at the same time and the swivel stand to be able to move in multiple directions on catalyst or manually;
a round, special effect lighting, digital, climate control, zero ounces in weight, multi colors, duroplastic and fiber glass coating transvermation speakers, for the transvermation speakers to digitally incorporate massive sound and ventilation controls as well as special effect lighting all digital through test tube lighting;
a square, illuminates, multi colors, zero ounces in weight, flat transvermation tnt keyboard/performance keys, for the transvermation tnt keyboard/performance keys to perform major multi task through wireless simulation automation conversions;
a square, illuminates, multi colored, glow key enhancements, duroplastic key moldings virtual conversion quarters, for virtual conversion quarters to convert and re-convert old commodities to suitable taste, securely connected to said Transvermation TNT Keyboard/Performance Keys;
a square illuminated keys, multi colored, zero ounces in weight, duroplastic base, glow key surface down and dirty digital mind renown, for the down and dirty digital mind renown to virtually and digitally enhance old school fun on many different levels for example virtual realistic dominoes, securely connected to said Transvermation TNT Keyboard/Performance Keys;
a square or flat, zero ounces in weight, multi colors, duroplastic coating, illuminates transvermation tower, for the transvermation tower to generate quadra transfers and conversions through air bellow transitions to perform many types of media conversions, wireless connected to said Down and Dirty Digital Mind Renown, wireless connected to said Virtual Conversion Quarters, wireless connected to said Transvermation TNT Keyboard/Performance Keys, wireless connected to said Transvermation Speakers, wireless connected to said Transvermation 1.5 Dimension Sun Screen Television Activity Monitor and the Swivel Stand, wireless connected to said Infrared Remote, wireless connected to said Dynomouse, and wireless connected to said TNT Data Master and Beyond Transvermation System;
an oblong oval shaped, multi-colored, illuminated/glo beams, soft cohesive plastic, miniature bit probes vcr integration with conversion style multi interface, for the vcr integration with conversion style multi interface to digitally convert mass quantities of media activities, combined with unorchestrated volumes of communication enhancements, securely connected to said Transvermation Tower;
a squared, multi colored, light enhanced, metal inserts, soft duro plastic molding, graphite edges d.a.t. intelligence style interface conversions (digital audio tape), for the d.a.t. intelligence style interface conversions (digital audio tape) to selectively engage in digital special effects in studio interface to integration connectivity operations, securely connected to said Transvermation Tower;
a circular, illuminated, plexi plastic base, multi colored, glo beam circuitry initial internet base all digital, all conversion mixing, for the initial internet base all digital, all conversion mixing to cross convert multi mix style integrations from audio to visual to communication as well as ada specifications and all forms of translations mix factors, securely connected to said Transvermation Tower;
a square, illuminates, duroplastic, graphite inserts, glo coils inserts all modern day digital enhancements conversions through mp3 slots style interface, for the all modern day digital enhancements conversions through mp3 slots style interface to enhance conversion navigation, explicitly rotating all levels of any serious varieties of mobile massive cargo, securely connected to said Transvermation Tower;
a square, illuminates, multi tooth ray enhancements, duroplastic surface, graphite moldings panoramic integrations via virtual conversions through digital expansions, for the panoramic integrations via virtual conversions through digital expansions to express the most vivid archives of multiple versatile tooth ray cross integration possible, securely connected to said Transvermation Tower;
a square, illuminates, glo circuitry, graphite molding, plexiglass inserts, energy efficient tubing multi stack conversion through digital processed intelligence, for the multi stack conversion through digital processed intelligence to aggressively save and combine massive libraries of conversion processing, extensively through integration housing bays embedded within multiple units of driver laboratories, securely connected to said Transvermation Tower;
a square, graphite molding, illuminates, zero ounces in weight, duroplastic coating capacity overload conversions start up system disk), for the capacity overload conversions start up system (disk) to systematically compose all integration illustrations into one gate for a rapid start up surge, securely connected to said Transvermation Tower;
a round, graphite surface, plexiglass moldings, illuminates, zero ounces in weight blue bay remote sensors, for the blue bay remote sensors to orchestrate massive cross signaling throughout system for repeatedly rapid response for rapid operations, securely connected to said Transvermation Tower;
a round, illuminates, zero ounces in weight, graphite molding, duroplastic coating extraordinary conversion ports such as cellphone/camera phone ports, for the extraordinary conversion ports such as cellphone/camera phone ports to digitally incorporate all signal/sensor portability within milliseconds in relationship, securely connected to said Transvermation Tower;
a round, graphite surface, duroplastic molding, zero ounces in weight, illuminates, multiple glo circuitry modified frequency conversion, for the modified frequency conversion to channel up, cross spit fire conversions through digital wave sequence and digital integration circumference with maximum standards in readiness, securely connected to said Transvermation Tower;
a round module, graphite surface, plexiglass moldings, duroplastic sidings, zero ounces in weight, illuminates, glo circuitry terminal conversion receiver, for the terminal conversion receiver to ultimately force digital streamlines of satellite bandwidth to form an extra strike impact in wave ratio and system production, securely connected to said Transvermation Tower;
a round, illuminates, graphite base, integrated duroplastic molding, zero ounces in weight, glo circuitry energy efficient iap integration protocol conversions, for the energy efficient iap integration protocol conversions to convert hand in hand with all media communications and probe satellite orchestrations as well as basic one on one cable enhancements digitally, securely connected to said Transvermation Tower;
a round, illuminated circuitry, zero ounces in weight, graphite coils, duroplastic molding, plexi adhesive siding internal/external link conversions, for the internal/external link conversions to form a massive media to communication community all within a fiber optic streamline of synchronized reproduction modules, securely connected to said Transvermation Tower;
an oval, graphite base, zero ounces in weight, illuminated circuitry, pin fiber optic wiring, duroplastic base sound/tuner cast conversions, for the sound/tuner cast conversions to convert massive swing operations through massive byte size circuitry pins all embedded on board or mm size fiber grid, securely connected to said Transvermation Tower;
a round, graphite base, zero ounces in weight, illuminated circuitry, duroplastic molding necessity conversions such as built in snoozer alarm, for the necessity conversions such as built in snoozer alarm to enhance a multiple new classification in wireless sensor configurations through advance analog and excessive exceleration for more on time connections, securely connected to said Transvermation Tower;
a round, zero ounces in weight, illuminated circuitry, graphite base built in internal/external microphone, for the built in internal/external microphone to involve multiple digital effects in a wireless spectrum of surround pan scanning and synchronized composed sequences, securely connected to said Transvermation Tower;
a square, zero ounces in weight, titanium base, illuminated circuitry, graphite moldings, duroplastic edges battery back up & life re-storage generator, for the battery back up & life re-storage generator to generate trillions of life cells within titanium style housing hub to form life even after the machine, securely connected to said Transvermation Tower;
a round, graphite base, illuminated circuitry, zero ounces in weight, duroplastic coating, plexiglass inserts integration through ram style interface, for the integration through ram style interface to selectively produce unrenowned combinations of memory access by multiple compartments of universal wireless intelligence working overtime, securely connected to said Transvermation Tower;
a round, graphite base, illumination circuitry, zero ounces in weight, multiple colors, duroplastic coating mini cordless sensor signal transmitters, for the mini cordless sensor signal transmitters to mingle and intertwine in many specific areas at one time to form an alliance of response cells through all digital transmissions, securely connected to said Transvermation Tower;
a round, graphite base, illuminate circuitry, duroplastic base, zero ounces in weight, multiple colors transvermation zoom in buttons, for the transvermation zoom in buttons to cross interface and override all forms of close encounter zoom and wide range entities to form a more aggressive and prompt ally through spit fire zoom intelligence, securely connected to said Transvermation Tower;
a round, zero ounces in weight, graphite base, illuminated circuitry, glo sensors, multiple colors, duroplastic moldings quadra zip drive/hard drive cross interface, for the quadra zip drive/hard drive cross interface to multi focus from a wide variety of ranges within circumference of a net base, enhanced cable ready colony for maximum handling and a more personal systematic relationship in a futuristic digital universe, securely connected to said Transvermation Tower;
a round, zero ounces in weight, illuminated circuitry, graphite base, duroplastic molding multi-wave files/mpeg style formatting transitions, for the multi-wave files/mpeg style formatting transitions to informatively reproduce potential memory identifiers through energy absorbing emissions, securely connected to said Transvermation Tower;
a round, graphite base, illuminated circuitry, glo wiring, zero ounces in weight extensive cable ready/digital live formatting, for the extensive cable ready/digital live formatting to consecutively recruit massive forms of stream cells through digital converting of media/communications and all new styles of mobile life abroad, securely connected to said Transvermation Tower;
a multi shaped, zero ounces in weight, multiple colors, graphite base, duroplastic coating, glow circuitry, illuminated wiring conversion pullout more personal expansions such as cd player, for the conversion pullout more personal expansions such as cd player to allow mobilosophy in the life in which we live, allowing individuals to manifest any conversion possible being able to customize constantly while they're doing it moving, securely connected to said Transvermation Tower; and
a square, mini grooves, mini notches, zero ounces in weight, illuminates, multi colors, duroplastic/rubber transvermation digital portability unit, for the transvermation digital portability unit to enable user to structure portability manually through remote systems and to translate circuit to circuit transactions with kamikaze infrastructure, securely connected to said Transvermation Tower.

37. A tnt data master & beyond or all digital studio hand or the ultimate duplication conversion or mobile intelligence or transformania pc (proper connectivity) or my mobilosophy or hand to handheld generation or mobile mogul or the all disposable pc or the conversion specialist or the all digital burn unit or mobile to mobiletainment or blend vision for through all mobile conversion enhancements and through omni/g-force circuitry integration users are enabled to convert all mass media conversion utility along with mainframe communication via broad/wireless communication such as 78, 45's 33's, cd's, dvd's, cassettes, 8-tracks, vhs, etc. into system or on standard up to date media utility through informant transformation integration, comprising:
a circular/square/rectangular, illuminates, duroplastic/plexiglass, zero ounces in weight tnt data master and beyond transvermation system, for the tnt data master & beyond to incorporate all entertainment metamorphosis and transfer needs through major streamline thoroughways and frequency modulating into one 62 inch transvermation 1.5 dimension sun screen television activity monitor through coversion magic, higher or lower in inches depending on preferences;
a round, zero ounces in weight, multi colors, duroplastic coating, illuminates dynomouse, for the dynomouse to correspond with system through mouse control;
a square/oval, illuminates, zero ounces in weight, multi colors, duroplastic coating infrared remote, for the infrared remote to remotely control the system;
a square, illuminates, zero ounces in weight, 3 buttons on top layer of frame, multi colors transvermation 1.5 dimension sun screen television activity monitor and the swivel stand, for the 1.5 dimension sunscreen television activity monitor and the swivel stand to be able to convert multi cable and satellite and perform a mirage of computerized activities at the same time and the swivel stand to be able to move in multiple directions on catalyst or manually;
a round, special effect lighting, digital, climate control, zero ounces in weight, multi colors, duroplastic and fiber glass coating transvermation speakers, for the transvermation speakers to digitally incorporate massive sound and ventilation controls as well as special effect lighting all digital through test tube lighting;
a square, illuminates, multi colors, zero ounces in weight, flat transvermation tnt keyboard/performance keys, for the transvermation tnt keyboard/performance keys to perform major multi task through wireless simulation automation conversions;
a square, illuminates, multi colored, glow key enhancements, duroplastic key moldings virtual conversion quarters, for virtual conversion quarters to convert and re-convert old commodities to suitable taste, securely connected to said Transvermation TNT Keyboard/Performance Keys;
a square illuminated keys, multi colored, zero ounces in weight, duroplastic base, glow key surface down and dirty digital mind renown, for the down and dirty digital mind renown to virtually and digitally enhance old school fun on many different levels for example virtual realistic dominoes, securely connected to said Transvermation TNT Keyboard/Performance Keys;
a square or flat, zero ounces in weight, multi colors, duroplastic coating, illuminates transvermation tower, for the transvermation tower to generate quadra transfers and conversions through air bellow transitions to perform many types of media conversions, wireless connected to said Down and Dirty Digital Mind Renown, wireless connected to said Virtual Conversion Quarters, wireless connected to said Transvermation TNT Keyboard/Performance Keys, wireless connected to said Transvermation Speakers, wireless connected to said Transvermation 1.5 Dimension Sun Screen Television Activity Monitor and the Swivel Stand, wireless connected to said Infrared Remote, wireless connected to said Dynomouse, and wireless connected to said TNT Data Master and Beyond Transvermation System;
an oblong oval shaped, multi-colored, illuminated/glo beams, soft cohesive plastic, miniature bit probes vcr integration with conversion style multi interface, for the vcr integration with conversion style multi interface to digitally convert mass quantities of media activities, combined with unorchestrated volumes of communication enhancements, securely connected to said Transvermation Tower;
a squared, multi colored, light enhanced, metal inserts, soft duro plastic molding, graphite edges d.a.t. intelligence style interface conversions (digital audio tape), for the d.a.t. intelligence style interface conversions (digital audio tape) to selectively engage in digital special effects in studio interface to integration connectivity operations, securely connected to said Transvermation Tower;
a circular, illuminated, plexi plastic base, multi colored, glo beam circuitry initial internet base all digital, all conversion mixing, for the initial internet base all digital, all conversion mixing to cross convert multi mix style integrations from audio to visual to communication as well as ada specifications and all forms of translations mix factors, securely connected to said Transvermation Tower;
a square, illuminates, duroplastic, graphite inserts, glo coils inserts all modern day digital enhancements conversions through mp3 slots style interface, for the all modern day digital enhancements conversions through mp3 slots style interface to enhance conversion navigation, explicitly rotating all levels of any serious varieties of mobile massive cargo, securely connected to said Transvermation Tower;
a square, illuminates, multi tooth ray enhancements, duroplastic surface, graphite moldings panoramic integrations via virtual conversions through digital expansions, for the panoramic integrations via virtual conversions through digital expansions to express the most vivid archives of multiple versatile tooth ray cross integration possible, securely connected to said Transvermation Tower;
a square, illuminates, glo circuitry, graphite molding, plexiglass inserts, energy efficient tubing multi stack conversion through digital processed intelligence, for the multi stack conversion through digital processed intelligence to aggressively save and combine massive libraries of conversion processing, extensively through integration housing bays embedded within multiple units of driver laboratories, securely connected to said Transvermation Tower;
a square, graphite molding, illuminates, zero ounces in weight, duroplastic coating capacity overload conversions start up system (disk), for the capacity overload conversions start up system (disk) to systematically compose all integration illustrations into one gate for a rapid start up surge, securely connected to said Transvermation Tower;
a round, graphite surface, plexiglass moldings, illuminates, zero ounces in weight blue bay remote sensors, for the blue bay remote sensors to orchestrate massive cross signaling throughout system for repeatedly rapid response for rapid operations, securely connected to said Transvermation Tower;
a round, illuminates, zero ounces in weight, graphite molding, duroplastic coating extraordinary conversion ports such as cellphone/camera phone ports, for the extraordinary conversion ports such as cellphone/camera phone ports to digitally incorporate all signal/sensor portability within milliseconds in relationship, securely connected to said Transvermation Tower;
a round, graphite surface, duroplastic molding, zero ounces in weight, illuminates, multiple glo circuitry modified frequency conversion, for the modified frequency conversion to channel up, cross spit fire conversions through digital wave sequence and digital integration circumference with maximum standards in readiness, securely connected to said Transvermation Tower;
a round module, graphite surface, plexiglass moldings, duroplastic sidings, zero ounces in weight, illuminates, glo circuitry terminal conversion receiver, for the terminal conversion receiver to ultimately force digital streamlines of satellite bandwidth to form an extra strike impact in wave ratio and system production, securely connected to said Transvermation Tower;
a round, illuminates, graphite base, integrated duroplastic molding, zero ounces in weight, glo circuitry energy efficient iap integration protocol conversions, for the energy efficient iap integration protocol conversions to convert hand in hand with all media communications and probe satellite orchestrations as well as basic one on one cable enhancements digitally, securely connected to said Transvermation Tower;
a round, illuminated circuitry, zero ounces in weight, graphite coils, duroplastic molding, plexi adhesive siding internal/external link conversions, for the internal/external link conversions to form a massive media to communication community all within a fiber optic streamline of synchronized reproduction modules, securely connected to said Transvermation Tower;
an oval, graphite base, zero ounces in weight, illuminated circuitry, pin fiber optic wiring, duroplastic base sound/tuner cast conversions, for the sound/tuner cast conversions to convert massive swing operations through massive byte size circuitry pins all embedded on board or mm size fiber grid, securely connected to said Transvermation Tower;
a round, graphite base, zero ounces in weight, illuminated circuitry, duroplastic molding necessity conversions such as built in snoozer alarm, for the necessity conversions such as built in snoozer alarm to enhance a multiple new classification in wireless sensor configurations through advance analog and excessive exceleration for more on time connections, securely connected to said Transvermation Tower;
a round, zero ounces in weight, illuminated circuitry, graphite base built in internal/external microphone, for the built in internal/external microphone to involve multiple digital effects in a wireless spectrum of surround pan scanning and synchronized composed sequences, securely connected to said Transvermation Tower;
a square, zero ounces in weight, titanium base, illuminated circuitry, graphite moldings, duroplastic edges battery back up & life re-storage generator, for the battery back up & life re-storage generator to generate trillions of life cells within titanium style housing hub to form life even after the machine, securely connected to said Transvermation Tower;
a round, graphite base, illuminated circuitry, zero ounces in weight, duroplastic coating, plexiglass inserts integration through ram style interface, for the integration through ram style interface to selectively produce unrenowned combinations of memory access by multiple compartments of universal wireless intelligence working overtime, securely connected to said Transvermation Tower;
a round, graphite base, illumination circuitry, zero ounces in weight, multiple colors, duroplastic coating mini cordless sensor signal transmitters, for the mini cordless sensor signal transmitters to mingle and intertwine in many specific areas at one time to form an alliance of response cells through all digital transmissions, securely connected to said Transvermation Tower;
a round, graphite base, illuminate circuitry, duroplastic base, zero ounces in weight, multiple colors transvermation zoom in buttons, for the transvermation zoom in buttons to cross interface and override all forms of close encounter zoom and wide range entities to form a more aggressive and prompt ally through spit fire zoom intelligence, securely connected to said Transvermation Tower;
a round, zero ounces in weight, graphite base, illuminated circuitry, glo sensors, multiple colors, duroplastic moldings quadra zip drive/hard drive cross interface, for the quadra zip drive/hard drive cross interface to multi focus from a wide variety of ranges within circumference of a net base, enhanced cable ready colony for maximum handling and a more personal systematic relationship in a futuristic digital universe, securely connected to said Transvermation Tower;
a round, zero ounces in weight, illuminated circuitry, graphite base, duroplastic molding multi-wave files/mpeg style formatting transitions, for the multi-wave files/mpeg style formatting transitions to informatively reproduce potential memory identifiers through energy absorbing emissions, securely connected to said Transvermation Tower;
a round, graphite base, illuminated circuitry, glo wiring, zero ounces in weight extensive cable ready/digital live formatting, for the extensive cable ready/digital live formatting to consecutively recruit massive forms of stream cells through digital converting of media/communications and all new styles of mobile life abroad, securely connected to said Transvermation Tower;
a multi shaped, zero ounces in weight, multiple colors, graphite base, duroplastic coating, glow circuitry, illuminated wiring conversion pullout more personal expansions such as cd player, for the conversion pullout more personal expansions such as cd player to allow mobilosophy in the life in which we live, allowing individuals to manifest any conversion possible being able to customize constantly while they're doing it moving, securely connected to said Transvermation Tower; and
a square, mini grooves, mini notches, zero ounces in weight, illuminates, multi colors, duroplastic/rubber transvermation digital portability unit, for the transvermation digital portability unit to enable user to structure portability manually through remote systems and to translate circuit to circuit transactions with kamikaze infrastructure, securely connected to said Transvermation Tower.
